(19) United States
(12) Patent Application Publication
(10) Pub. No.: US 2022/0072647 A1
(43) Pub. Date: Mar. 10, 2022

(54) BALANCED WELDING OF DISSIMILAR MATERIALS

(71) Applicant: KTH Parts Industries, Inc., St. Paris, OH (US)

(72) Inventor: Nathan Cloeter, Delaware, OH (US)

(73) Assignee: KTH Parts Industries, Inc., St. Paris, OH (US)

(21) Appl. No.: 17/015,449

(22) Filed: Sep. 9, 2020

(51) Int. Cl. B23K 11/20; B23K 11/24; B23K 11/11; B23K 11/36; B23K 11/30; B23K 103/04; B23K 103/10; B23K 101/00

(52) U.S. Cl. CPC B23K 11/20; B23K 11/24; B23K 11/115; B23K 2101/006; B23K 11/3018; B23K 2103/04; B23K 2103/10; B23K 11/36

(57) ABSTRACT

A multi-tiered weld program that is effective in resistance spot welding of dissimilar materials is disclosed. The process is repeatable across a multitude of grades/thicknesses, and number of sheets of conductive materials, and is possible to perform with traditional weld tooling and electrodes. Different size/different material/different contact face geometries weld surfaces are used to balance thermal properties of the materials, and the process is designed to create a small, consistent Intermetallic Compound (IMC) that is effective in holding two different conductive materials together with a high level of strength that is suitable for industrial mass production. The multi-tiered resistance spot weld process uniformly preheats, welds, and cools the samples to control the formation of the IMC that is formed therein.

### FIELD

The field of the present disclosure is related to systems and methods for resistance spot welding and, more particularly, to such systems and methods that consistently form an integral Intermetallic Compound (IMC) between two dissimilar materials.

### BACKGROUND

Resistance spot welding is a process in which metal surface points that are in contact with each other are joined (i.e., welded together) by heat obtained from resistance of an electrical current. In resistance spot welding, two electrodes concentrate the electrical current into a spot while pressing the work pieces together. The work pieces may include metal sheets that, during the welding process, are held together under pressure exerted by the electrodes. Forcing the electrical current through the spot will melt the metal and form a weld joint (commonly known as a “nugget”) at the point of pressure after solidification. This re-solidified material helps to join the two materials together. In certain scenarios, when two different materials are spot welded together, a thin IMC will form between the materials in lieu of a weld nugget. This IMC forms in lieu of a weld nugget due to the differences in thermal and electrical properties between the materials being joined. Due to the differences in properties when welding two dissimilar materials together, one material will tend to melt before the other material and instead of a nugget forming, particles will diffuse from one material to the other material in a limited space to form a strong alloy between the two materials. However, due to the similarities in equipment and joining process, we will refer to the joint as a “weld” for simplicity and familiarity.

Resistance spot welding is a popular joining process that is utilized in a large number of applications, such as automated assembly line applications, due to its economical and efficiency advantages. Therefore, resistance spot welding is the most popular joining process in the automotive industry for assembling automobile bodies. Resistance spot welding is also widely used in other industries, such as the manufacture of furniture and domestic equipment, etc. Resistance spot welding is efficient because it can produce a multitude of spot welds in a short period of time. For example, resistance spot welding permits welding to occur at localized areas of metal sheets without excessive heating of the remainder of the metal sheets. When welding dissimilar materials, however, special care needs to be taken in regards to the differences in properties between the two dissimilar materials being welded. Differences in thermal conductivity, melting point, and thermal expansion can lead to certain combinations of dissimilar materials being joined together by an IMC instead of a weld nugget. These differences in material properties need to be properly balanced while determining the most effective way to form the IMC in order to ensure what is formed is uniform and consistent for optimized weld strength.

Dependence upon traditional spot welding techniques that are utilized for welding the same types of material together, such as steel to steel, results in the formation of an IMC that is unstable, and therefore unsuitable for use in industrial applications. Multiple entities have made attempts to introduce additional processes and materials, such as interlayer inserts, or fixtures that redirect heating, to counter the imbalance in thermal properties. However, these products are not ideal for use in mass production applications due to their limitations. Previous attempts have also been made to join two dissimilar materials by either redirecting heat through an additional ground, or by reducing the buildup of heat in the interface by stopping weld currents at various points to grow a uniform IMC over a staged period of time and current. However, these attempts are unsatisfactory because they either add cost to the process or extend cycle times, making them less efficient.

Advances and improvements to systems and methods for resistance spot welding are continuously in demand to make the process more cost efficient. Improvements that utilize traditional weld tooling are viewed as the most cost effective solutions when compared to current dissimilar material fastening applications. Accordingly, there is a need for improved resistance spot welding systems and methods that consistently form an integral IMC between two dissimilar materials (in those cases in which an IMC is formed).

### SUMMARY

Disclosed are systems and methods for resistance spot welding dissimilar materials which overcome at least some of the above described limitations of the prior art. Disclosed is a resistance spot welding method for joining dissimilar materials together that includes the steps of pressuring the upper and lower work pieces to clamp the work pieces together with opposed upper and lower weld electrodes of a weld machine. In a preheating phase, with the work pieces pressured and clamped together by the weld electrodes, electrical current is provided through the weld electrodes to the work pieces at a predetermined level and a predetermined period of time to provide gradual heating of the work pieces. In a welding phase after the preheating phase, with the work pieces pressured and clamped together by the weld electrodes, electrical current is provided through the weld electrodes to the work pieces at a predetermined level higher than the preheating phase and a predetermined period of time to form an IMC between the work pieces. The electrical current is continuously provided to the work pieces from the preheating phase through welding phase without stops.

Also disclosed is a resistance spot welding method for joining work pieces of dissimilar materials together that includes the steps of a resistance spot welding method for joining work pieces of dissimilar materials together, the method comprising the steps of pressuring the work pieces to clamp the work pieces together with opposed weld electrodes of a weld machine. In a preheating phase, with the work pieces pressured and clamped together by the weld electrodes, electrical current is provided through the weld electrodes to the work pieces at a predetermined level and a predetermined period of time to provide gradual heating of the work pieces. In a welding phase after the preheating phase, with the work pieces pressured and clamped together by the weld electrodes, electrical current is provided through the weld electrodes to the work pieces at a predetermined level higher than the preheating phase and a predetermined period of time to form an IMC between the work pieces. In a sloping phase between the preheating phase and the welding phase, with the work pieces pressured and clamped together by the weld electrodes, electrical current provided to the work pieces gradually rises from the predetermined level of the preheating phase to the predetermined level of the welding phase over a predetermined period of time. Rate of cooling of the work pieces can be increased after the tempering phase using cooling fluid flowing in the weld electrodes while the weld electrodes continue to pressure and clamp the work pieces together for a predetermined period of time with constant pressure and no electrical current flowing to the work pieces. The electrical current is continuously provided to the work pieces throughout the preheating, sloping, and welding phases without stops.

From the foregoing disclosure and the following more detailed description of various preferred embodiments, it will be apparent to those skilled in the art that the present disclosure provides a significant advance in the technology of systems and methods for resistive spot welding of dissimilar materials. Particularly significant in this regard is the potential the invention affords for providing an effective system and method that can reliably utilize traditional weld tooling. Additional features and advantages of various preferred embodiments will be better understood in view of the detailed description provided below.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a side view of a welding machine during an exemplary welding operation, in accordance with some or all of the principles of the present disclosure.

FIG. 2A is a flow chart of a typical welding process for similar material (e.g. steel-to-steel) resistance spot welding. This process features electrodes squeezing the work pieces together, and a welding process occurs when a predetermined current, that can be either constant or varying, runs through the electrodes and materials for a predetermined period of time. This process is continuous from beginning to end.

FIG. 2B is a weld chart of the flow chart identified in FIG. 2A.

FIG. 2C. is a Scanning Electron Microscopy (SEM) image of an IMC that was formed in a similar manner to the weld and flow charts identified in FIG. 2A and FIG. 2B. The IMC that forms is inconsistent and filled with cracks and voids.

FIG. 2D. is a side view of the different sizes of weld electrodes utilized between the dissimilar materials to counteract the differences in thermal conductivity between the work pieces.

FIG. 3A is a flow chart of a multi-tiered welding process in accordance with some or all of the principles of the present disclosure. This process features electrodes squeezing the work pieces together, and a welding process featuring preheat, slope, weld, tempering, and holding current stages of welding. This process is continuous from beginning to end.

FIG. 3B is a weld chart of the flow chart identified in FIG. 3A.

FIG. 4A is a technical drawing of a cross section of welds produced by a schedule represented by FIG. 3A and FIG. 3B.

FIG. 4B is a microscopic cross section of a weld produced by a schedule represented by FIG. 3A and FIG. 3B.

FIG. 4C is an SEM image of an IMC that was formed in a similar manner to the weld and flow charts identified in FIG. 4A and FIG. 4B. The IMC that is formed shows significantly fewer cracks and voids compared to FIG. 2C.

FIG. 5A is a flow chart representing an alternate method for forming an IMC where the welding process has a plurality of preheating steps to better control the heating of the work pieces.

FIG. 5B is a weld chart of the flow chart identified in FIG. 5A.

FIG. 6A is a flow chart representing an alternate method for forming an IMC where the welding process has a plurality of continuous welding steps to better control the cooling of the work pieces.

FIG. 6B is a weld chart of the flow chart identified in FIG. 6A.

FIG. 7A is a flow chart representing an alternate method for forming an IMC that skips the tempering step and goes instantly to cooling by holding the work pieces with cooled weld tips.

FIG. 7B is a weld chart of the flow chart identified in FIG. 7A.

FIG. 8A is a flow chart representing an alternate method for forming an IMC where the welding process has a plurality of temper steps to better control the cooling of the work pieces.

FIG. 8B is a weld chart of the flow chart identified in FIG. 8A.

### DETAILED DESCRIPTION

It will be apparent to those skilled in the art, that is, to those who have knowledge or experience in this area of technology, that many uses and design variations are possible for the improved systems and methods disclosed herein. The following detailed discussion of various alternative and preferred embodiments will illustrate the general principles of the invention. Other embodiments suitable for other applications will be apparent to those skilled in the art given the benefit of this disclosure.

Embodiments discussed herein describe a novel process using current resistance spot welding tooling to join dissimilar materials together. Some of the embodiments describe differing electrodes that are used to join the two materials together. These electrodes are selected to counteract the thermal properties of the different materials by balancing the flow of heat as current travels between the materials. The electrode for the more conductive material is significantly larger in diameter than the electrode for the more resistive material due to the difference in properties such as thermal conductivity and melting point. These embodiments result in sufficiently heating the resistive side while avoiding molten expulsion from the conductive side. In some cases, the heat flow balance may also be achieved by using electrode contact surfaces or tips of different materials and/or different contact face geometries.

Other embodiments disclosed herein describe a welding process using existing technology in a novel way to consistently form an IMC to thermally join dissimilar materials. Such embodiments include the use of a complex, multi-tiered weld program containing multiple spot welding programs combined into one continuous program to distribute heat across the weld interface to produce a uniform IMC. This multi-tiered weld program helps to distribute the heat across the interface to form a consistent and integral IMC. This method not only improves mechanical strength compared to traditional resistance spot welding, but also has the potential to do so in a method that is comparably faster than other methods.

The presently disclosed embodiments provide distributed heat between dissimilar materials in a controlled manner. These embodiments assist in counterbalancing the different thermal properties between the dissimilar materials, to deliver a satisfactory amount of heat to join them together. Methods disclosed herein occur while avoiding unfavorable welding conditions such as expulsion, or an inconsistent IMC, from forming. This resulting IMC is thin, but spreads across the entire weld surface in a consistent manner. The IMC also contains a significantly reduced amount of cracking so that it is suitable for use in industrial production.

In contrast to existing processes in the prior art, these methods will effectively join two different conductive materials together using existing weld tooling, while not requiring a fastener to initially join the pieces together. These methods also do not require any additional attachments to the weld tooling to redirect heat, or a cladding material to place in between the materials. These methods also are continuous, without any stops needed to reform the molten materials before continuing. The multi-tiered weld programs described herein occur in one continuous stream of current using traditional welding machines to effectively join dissimilar materials by effectively distributing the heat in manner that is congruent with the different thermal properties of the materials being joined.

Typically, the multi-tiered weld programs will maintain a consistent current for each tier of the welding process. However, current is able to change in a manner that is deemed suitable for any stack-up of dissimilar materials that are being joined. This includes, but is not limited to, increasing current in a sloping manner, an alternating pulse function, and the like. This is allowable as long as current continues to run in an unbroken manner from start to finish. These methods are repeatable across multiple stack-ups, and is more effective than traditional welding, while potentially being faster and more efficient than other solutions available.

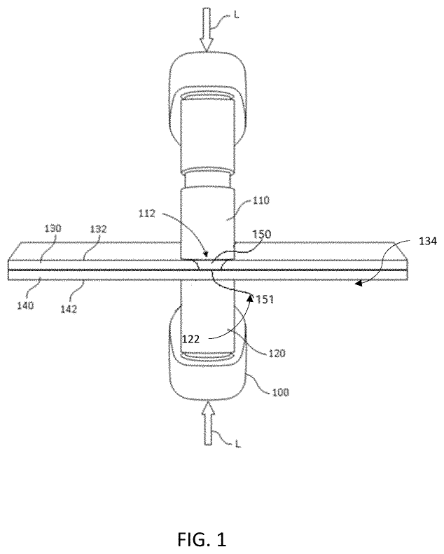

FIG. 1 illustrates an example of a resistance welding machine or system 100 according to the present subject matter. The welding machine 100 may utilize a variety of robotic or non-robotic welding apparatuses, and may generally include any type of welder capable to provide the necessary welding program to the interface of the materials being joined. In some examples, the welding machine 100 is a servo-driven welder, whereas in other examples the welding machine 100 is a pneumatic-driven welder; however, any other type of welding apparatus that are capable of performing similar techniques may be utilized without deviating from the present disclosure.

As illustrated, the welding machine 100 includes an upper electrode 110 and an opposed lower electrode 120. The upper electrode 110 comes into contact with an upper metal surface 132 of an upper metal work piece as the lower electrode 120 comes into contact with a lower metal surface 142 of a lower metal work piece. The illustrated metal work pieces are metal sheets but can alternatively be of any other suitable type. This process, which currently being depicted with two sheets, also has the potential to add more than two sheets to the joining process. Both the upper and lower electrodes 110, 120, are depicted as having a cylindrical shaped both with differing uniform radii and shaped faces. FIG. 1 illustrates the electrodes 110, 120 with flat weld surfaces. However, in other situations or embodiments, the weld surfaces of the electrodes 110, 120 may have any combination of flat, inward, or outward curvatures.

Either the upper electrode 110, and/or the lower electrode 120, may include any variety of geometries. For example, any combination of the upper and/or lower electrodes 110, 120 may each be of a certain shape, such that either the top electrode contact surface 112, or the bottom electrode contact surface 122, are rounded weld surfaces on ends of the frusto-conical shaped body and defined by a truncated end radius of the ends of the cylindrical body. In most embodiments of dissimilar welding, geometry of the upper electrode 110 is different than the geometry of the lower electrode 120. The upper electrode 110 and lower electrode 120, may include any variety of shape and geometries. Regardless of the electrode geometry and weld surface shape, the electrode contact surfaces 112, 122 may be provided as flat weld surfaces or with inward or outward protruding curvatures. The electrode surfaces 112, 122 can be smooth or they can have a textured surface comprising of plurality of male or female oriented features that are selected from a group consisting of raised or depressed features (teeth, knurls, protrusions, depressions, ridges, asperities, cross-hatches, parallel or non-parallel lines, star shapes, triangles, hexagons, etc. and combinations of the same). This texture helps to break the oxide layer on the surface wherever applicable. For further information on the textured weld surface, refer to Patent Publication Number WO/2020/068575, International Application Number PCT/US2019/052094, which is expressly incorporated herein in its entirety by reference.

During a typical resistance spot welding operation, the upper electrode contact surface 112 of the upper electrode 110 is pressed against an upper metal part or work piece 130 with a set force to deliver an optimal pressure, while the lower electrode surface 122 of the lower electrode 120 is pressed simultaneously with the upper electrode 110 against a lower metal surface 142 of lower metal part 140 with a set or predetermined force to deliver the optimal pressure. The electrodes 110, 120 press the work pieces 130, 140 together with the set force at a simultaneous occurrence. As illustrated, the upper electrode contact surface 112 of the upper electrode 110 is pressed against the upper metal surface 132 of the upper metal part 130 simultaneously with the lower electrode 120 pressing against the lower metal surface 142 of lower metal part 140. The welding machine 100 then passes adequate electrical current between the upper and lower electrodes 110, 120 and across the interface of upper and lower metal parts 130, 140 to create a weld nugget after solidification.

Weld schedules are integral to forming an IMC due to the role they play in the quality of the joint that is formed. A properly balanced weld schedule forms a consistent, robust IMC of optimal thickness. Consistent IMCs of optimal thickness reduce the number of cracks in the alloy that forms between the dissimilar materials, which reduces the number of points where internal failure can occur. This results in higher levels of strength being achievable for welding of dissimilar materials, as well as increased performance in fatigue, and other forms of cyclical testing. The illustrated weld machine includes a suitable system processor and memory which utilizes software or programming code to carry out the weld schedules or programs and other steps disclosed herein below.

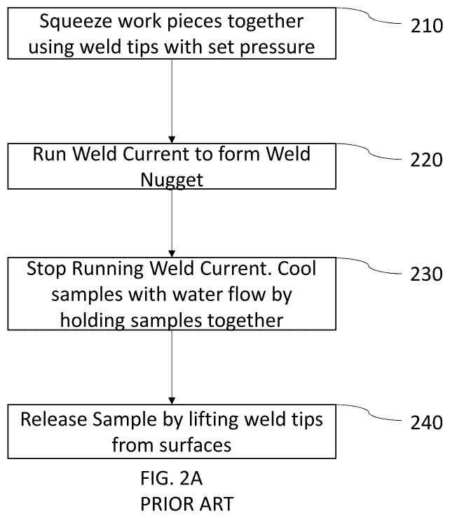

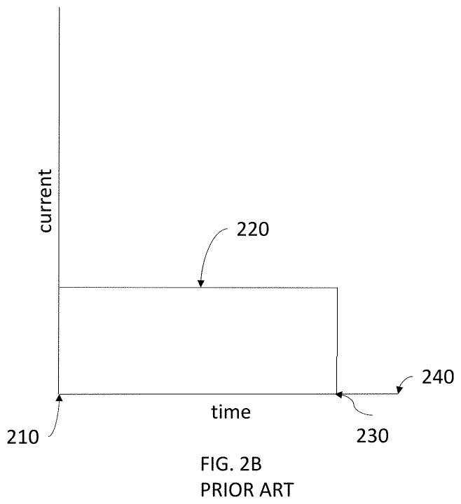

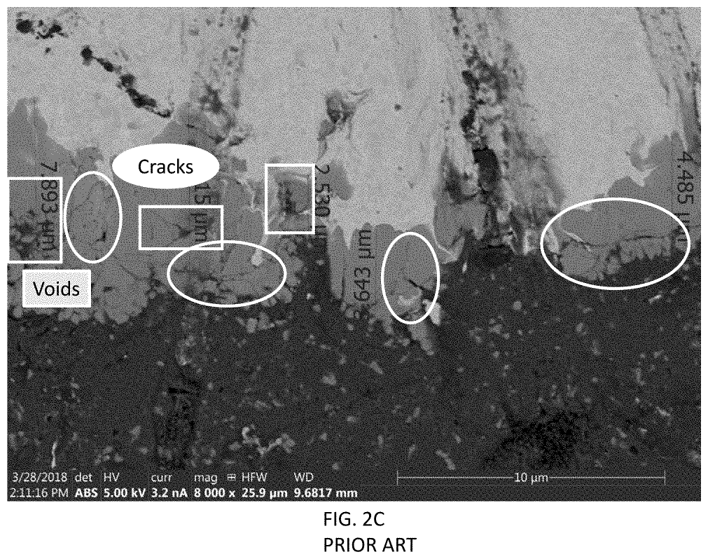

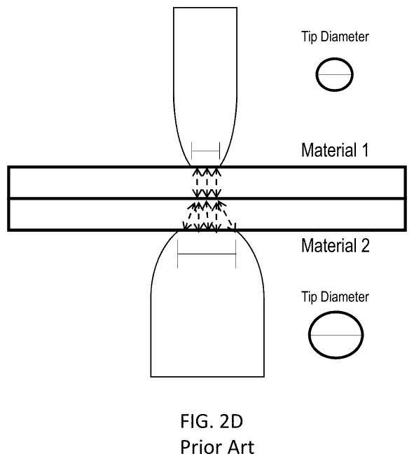

FIG. 2A and FIG. 2B illustrate an example of a typical prior art welding program used in traditional steel to steel welding. This process features electrodes squeezing the work pieces together, and a welding process occurs when a set amount of current runs through the tips of the electrodes and the work pieces for a given period of time. This process is continuous from beginning to end. FIG. 2A is a flowchart of the example showing process steps 210, 220, 230, and 240, and FIG. 2B is a weld graph of the example. FIG. 2B presents the weld graph by charting the progression of electrical current flowing through the work pieces over time from process step 210 to process step 240. When the traditional welding program is used to join dissimilar materials, the IMC that forms is inconsistent and erratic in terms of size and shape. In certain cases, IMCs may not form and something else forms in lieu of it. These irregularities lead to excessive defects such as voids and cracks and reduce the potential strength of the alloy that holds the dissimilar materials together. FIG. 2C shows an exemplary SEM image of a weld that resulted from this traditional welding program, and shows the shortcomings of using traditional resistance spot welding methods to join dissimilar materials. This IMC contains many defects, such as voids and cracks, and may lead to insufficient weld strength. FIG. 2D shows a side view of the different size weld electrodes that are needed to counteract the differences in thermal conductivity between the dissimilar work pieces.

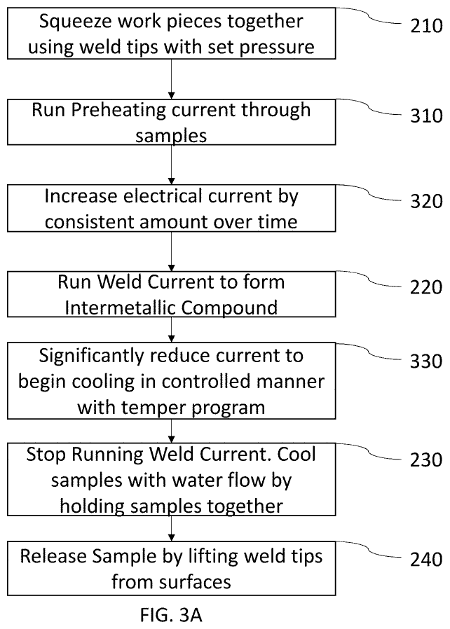

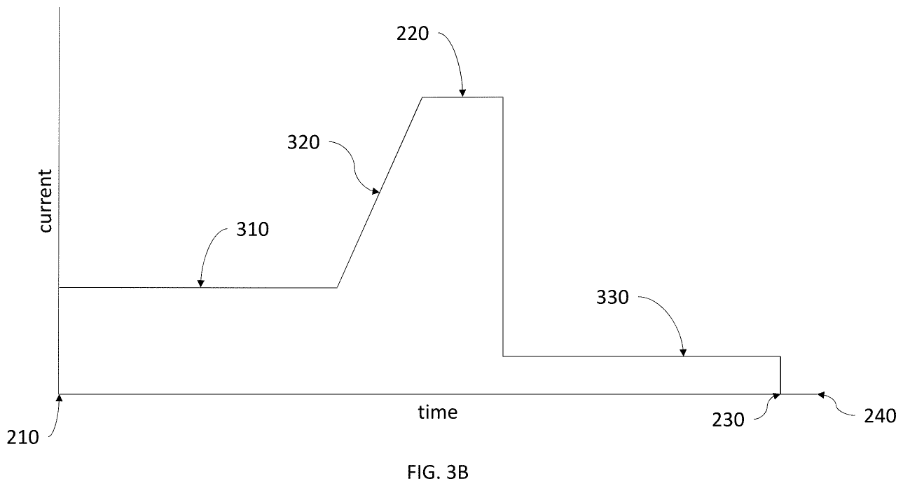

FIG. 3A and FIG. 3B illustrate an example of a continuous weld program of a preferred embodiment of this disclosure. Various preferred embodiments disclosed herein will follow the same general flow to properly distribute heat for the proper formation of IMC. Heat is distributed across several stages of the welding process to form an IMC that is robust and structurally functional. FIG. 3A is a flowchart of the example having process steps 210, 310, 320, 220, 330, 230, and 240. FIG. 3B is a weld graph of the example showing the progression of the electrical current flowing through the work pieces over time from process step 210 to process step 240.

The upper and lower weld electrodes, 110, 120 squeeze the metal parts or work pieces 130,140 at contact surfaces 112, 122, together at a set or predetermined pressure for a predetermined period of time 210. This pressing of the weld electrode contact surfaces 112, 122 enables the upper and lower electrodes 110, 120 to break the outer oxide layers of their respective material surfaces 132, 142, should they exist. The upper electrode 110 creates openings in the oxide of the upper metal part 130 to facilitate a more effective flow of current, while sustaining tip life by preventing the electrode surface 112 from sticking to the upper metal part 130 being joined. The lower electrode 120 creates openings in the oxide (should an oxide layer exist) of the lower metal part 140 to facilitate a more effective flow of current. This approach has the potential to be extended to join more than two sheets of dissimilar materials.

With the examples of aluminum and steel as the dissimilar materials, the weld program utilizes a preheating program 310 to uniformly heat the joining around between the upper metal parts 130 and lower metal parts 140. The electrical current is then sloped up gradually, 320, to melt the coating on the steel and to facilitate a phase change from a Body Centered Cubic phase to a Face Centered Cubic phase. It is noted that while the exemplary slope is constant to provide a straight angled line, any other suitable rise can alternatively be used such as, but not limited to, a concave curve, a convex curve, steps, and the like. It is also noted that the sloping phase can also be eliminated if desired. After this phase change, iron ions will diffuse into the aluminum to facilitate the creation of the IMC. In the case of welding aluminum and steel, the aluminum could be 5xxx, 6xxx, 7xxx, 8xxx or any other alloy of aluminum in different tempers and thicknesses and may be uncoated or have different types of surface coatings. Similarly, the steel may be coated or uncoated in different thicknesses and could have different material strengths (such as but not limited to low carbon steel, medium strength steels, high strength steels, hot stamped boron steel, stainless steel, etc.). Other dissimilar material combinations (besides aluminum and steel) could also be joined by this approach. Different materials can be joined if they interact in a similar method to aluminum and steel when placed under electrical current and pressure. The changes in phases and crystal structure will depend on the dissimilar materials being joined. A variety of suitable times and electrical currents can be used, and the current progression is not tied to the current values used in the preheating or welding phases.

During the creation of the IMC, the electrical current of the sloping phase 320, will turn to a consistent or continuous predetermined current 220, and weld the dissimilar materials together to form a thin, consistent IMC. A variety of suitable electrical currents and weld times can be used herein.

After the IMC has been formed, cool down of the metal parts 130, 140 begins. A tempering phase 330 is performed across the weld interface with the weld electrodes 110, 120. The tempering of the metal parts 130, 140 is performed at a comparably lower electrical current than the preheating, sloping, or welding phases or stages, and allows for the temperature to gradually drop. This gradual drop allows for a controlled material transition throughout the material that melts initially due to the lower melting point to solidify into a region cooling in a controlled manner to limit the thermal stress on the IMC. This limitation on thermal stress reduces cracking in the IMC, resulting in a reduction of propagation points for failure.

At the end of the tempering phase or stage when the weld program has finished running electrical current across the metal parts 130, 140, the electrodes 110, 120 keep the metal parts 130, 140 held together for a defined or predetermined period of time 230. Water or any other cooling agent will continue to flow through the electrodes 110, 120 during this hold time to cool both the metal parts 130, 140 and the electrodes 110, 120. Once the metal parts 130, 140 are held for a set or predetermined period of time, the upper and lower weld electrode surfaces 112, 122 release the sample with the fully formed IMC, 151, at time 240, signaling the end of the welding process.

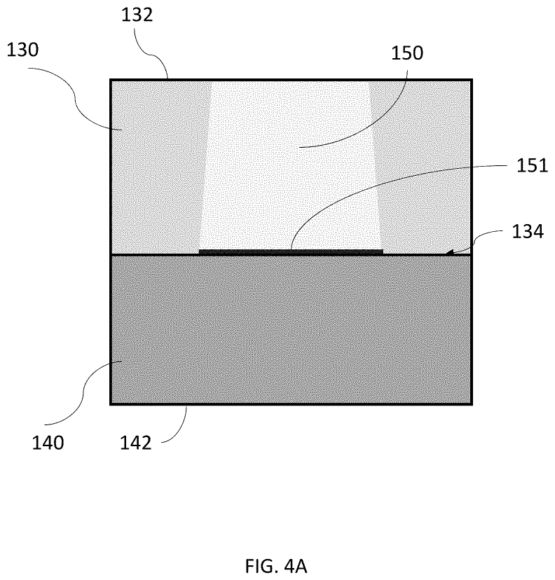

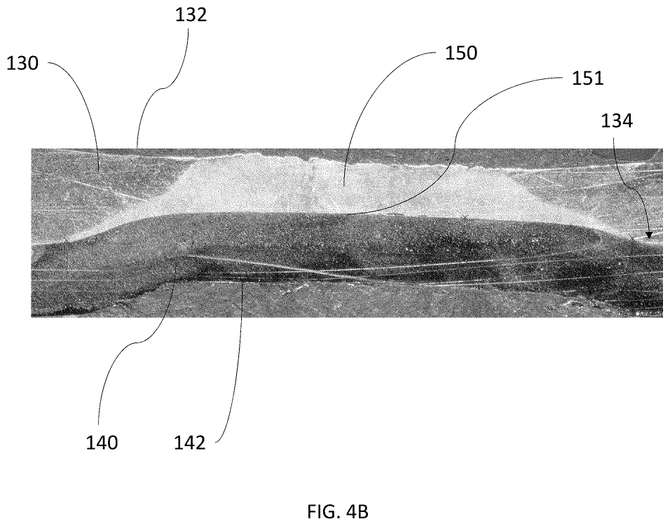

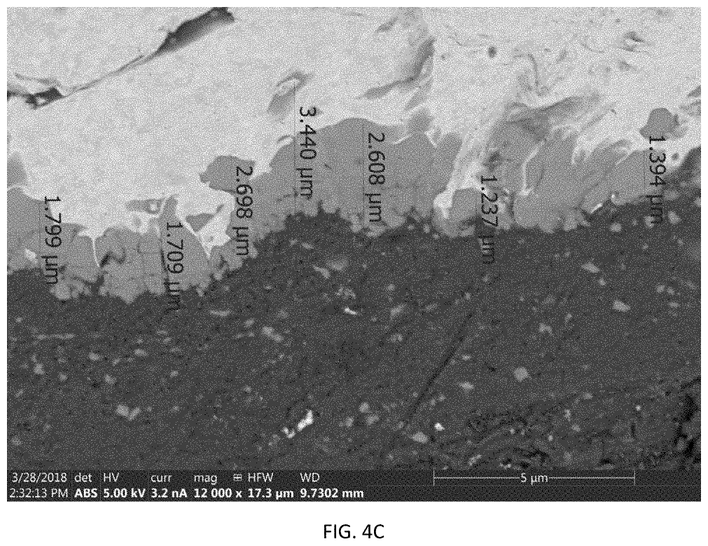

FIGS. 4A to 4C illustrate the cross-sectional view of a joint after a successful weld process is performed as described above with regard to FIGS. 3A and 3B. An IMC has formed between the dissimilar materials, successfully welding them together. The more conductive material melted and reformed in the region where current travelled on the top side of the IMC. FIG. 4A gives a technical drawing of the cross section produced herein. With the example of the upper metal part 130 being aluminum and the lower metal part 140 being steel, this is obtained after melting and re-solidifying the aluminum at region 150 as a solidified deposit that sits on top of IMC 151. The steel that is used as lower metal part 130 transitions from a Body Centered Cubic (BCC) phase to a Face Centered Cubic (FCC) phase, and then back to a BCC phase upon cooling. The changes in the crystal structure will depend on the materials being joined. The upper and lower electrode surfaces 112, 122 may have a specified hardness and contour that are designed for a particular welding application. FIG. 4B gives microscopic view of the cross section produced herein. FIG. 4C gives an SEM image of a weld resulting from the above disclosed method, and shows how utilizing a complex, multi-tiered welding program can fix the problems created with traditional welding to give a robust, functional IMC. This results in high amounts of strength for dissimilar welding as well as increased performance in fatigue and other forms of cyclical testing.

The weld electrodes 110, 120 preferably each have a contact surface 112, 122 that is oriented so that current flow in the work pieces 130, 140 facilitates Peltier Effect. The Peltier Effect is a thermoelectric effect that takes place when an electric current is put through two contacting conductive, but dissimilar, materials. Due to this effect, one material will give heat to the other material to balance the gap in chemical potential. As such, current flow can be aligned in a certain direction in order to facilitate the Peltier Effect.

The contact surface 112, 122 of the weld electrode 110, 120 that is contacting a more conductive one of the dissimilar materials of the work pieces 130, 140 preferably has an equivalent ratio of diameter to the contact surface 112, 122 of the weld electrode 110, 120 contacting a less conductive one of the dissimilar materials of the work pieces 130, 140 to counteract a gap in thermal conductivity and thermal expansion between the dissimilar materials. The contact surface 112, 122 that is chosen to be used on the more conductive side must be at least the equivalent ratio of the diameter to the contact surface 112, 122 applied to the less conductive material so that the gap in thermal conductivity and thermal expansion between dissimilar materials can be properly counteracted. In some cases, the heat flow balance may also be achieved by using weld electrodes 110, 120 of different materials and/or different contact face geometries.

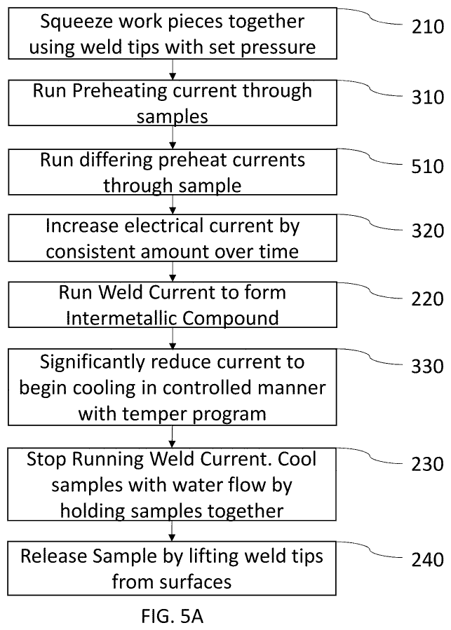

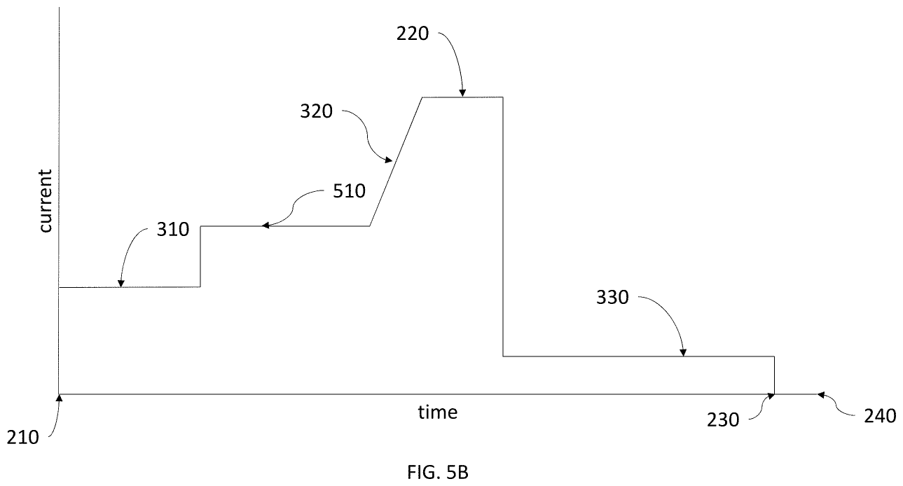

Certain complexities inherent in the materials discussed herein, and the IMC that joins them together, will occasionally require a higher level of program variance to facilitate proper bonding. Some factors that will impact the complexity of the welding procedure are (but not limited to) surface condition of the material (oxide scale, debris, contaminants, etc.), grades and thickness of materials being joined, geometry of materials being joined, presence of intermediate layer between the materials (adhesive, sealer, etc.), and number of sheets being joined. There could be several other factors that will have an impact on the weld schedule. The program variance manifests itself by introducing additional tiers of electrical current to the multi-tiered welding schedule. These additional levels of complexity are disclosed in FIGS. 5-8. The process disclosed herein is not limited to the following figures. FIGS. 5-8 are further examples of the process being disclosed. Weld programs may contain a variety of current levels that change in different amounts over time. Actual programs may vary between the figures discussed herein.

FIGS. 5A and 5B represent a weld process modified from the weld process of FIGS. 3A and 3B, wherein the welding process goes through multiple levels of preheating phases or steps 310, 510, before sloping to the weld phase or step 220. Multiple preheating tiers can be used to utilize a higher level of control over the dissimilar materials in situations where the materials can be sensitive to changes in thermal loads. Levels of preheating can either increase or decrease to meet the demands of the material being joined, as long as there is no stoppage of current, and the final preheating step progresses by sloping current into the weld step. While the example shown has two preheating steps 310, 510, it is noted that any other suitable plurality of preheating steps can alternatively be utilized if desired. FIG. 5A is a flowchart of the example, while FIG. 5B is a weld graph of the example having process steps 210, 310, 510, 320, 220, 330, 230, and 240. FIG. 5B presents the weld graph by charting the progression of the electrical current flowing through the weld materials over time from process step 210 to process step 240. The number of levels of preheating will depend on the type of phase changes that take place and the associated diffusion rates required to form the IMC (in cases where it is formed). There could be some additional benefits of preheating that are dependent on the metal parts 130, 140 being welded.

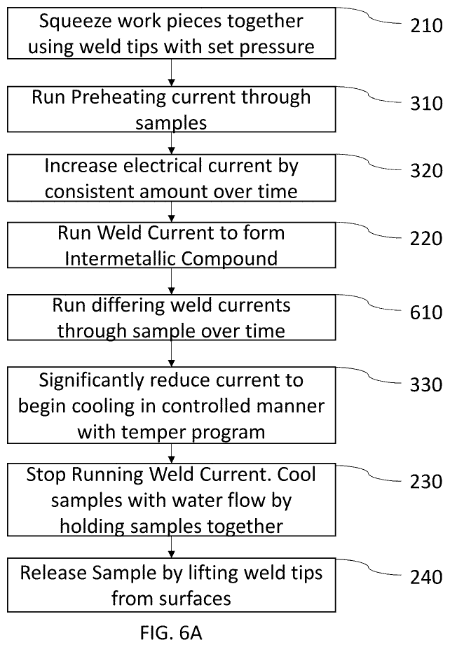

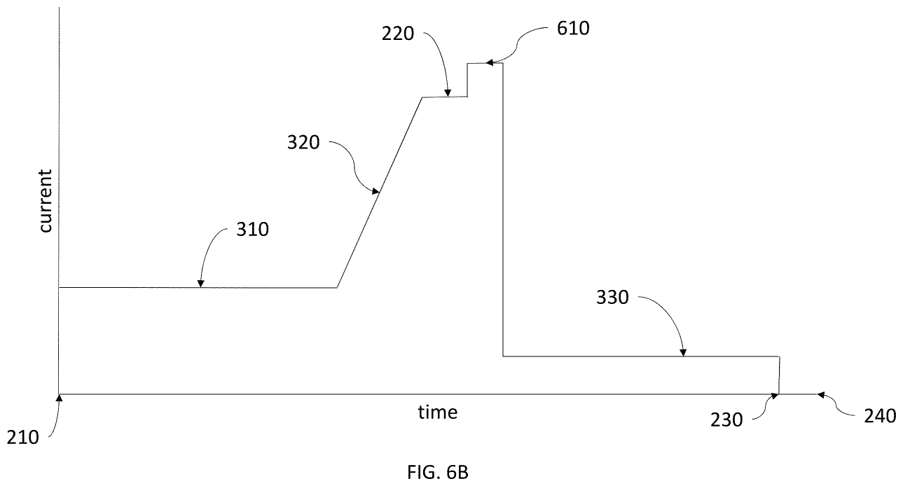

FIGS. 6A and 6B represent a weld process modified from the weld process of FIGS. 3A and 3B wherein the weld process goes through multiple levels of welding, 220, 610, before cooling down. Multiple levels of welding can be utilized to maintain a higher level of control over the types and concentrations of phases that are being created to make up the IMC. Levels of welding can either increase or decrease to meet the demands of the material being joined, as long as there is no stoppage of current, and the final welding step progresses into the cooling phase. While the present example shown has two welding steps 220, 610, it is noted that any other suitable plurality of welding steps can alternatively be utilized if desired. FIG. 6A is a flowchart of the example having process steps 210, 310, 320, 220, 610, 330, 230, and 240. FIG. 6B is a weld graph of the example. FIG. 6B presents the weld graph by charting the progression of the electrical current flowing through the metal parts 130, 140 over time from process step 210 to process step 240.

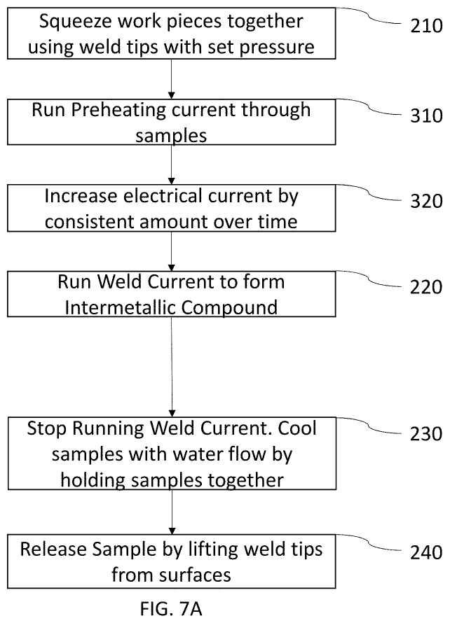

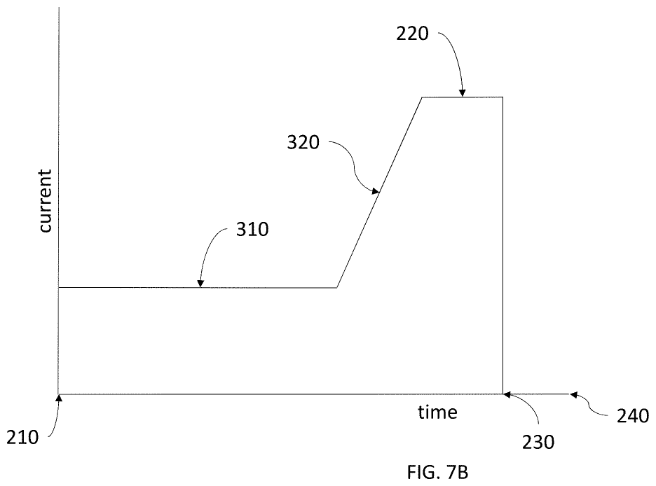

FIGS. 7A and 7B represent a weld process modified from the weld process of FIGS. 3A and 3B wherein the weld process bypasses any tempering phase to go straight to the weld surfaces holding the welded materials without current running through them to cool down the joined materials. Certain material combinations may not need the tempering phase to facilitate proper formation of the IMC. This can result in significant cost savings by way of a reduced process time. FIG. 7A is a flowchart of the example having process steps 210, 310, 320, 220, 230, and 240. FIG. 7B is a weld graph of the example having process steps 210, 310, 320, 220, 230, and 240. FIG. 7B presents the weld graph by charting the progression of the current flowing through the metal parts 130, 140 over time from process step 210 to process step 240.

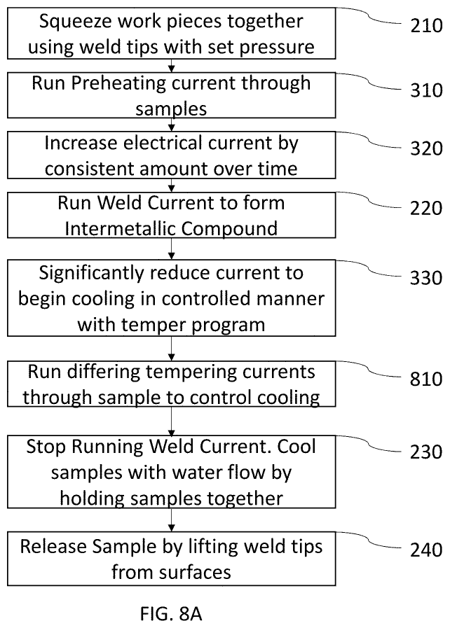

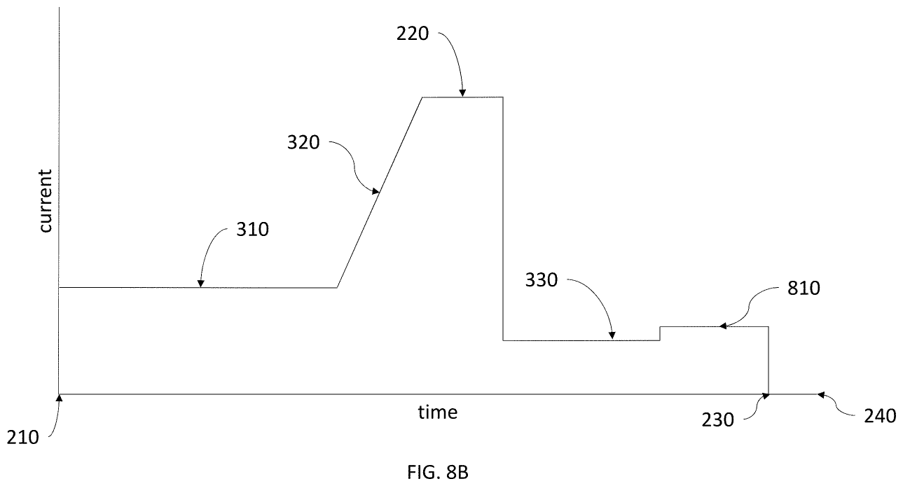

FIGS. 8A and 8B represent a weld process modified from the weld process of FIGS. 3A and 3B wherein the weld process goes through multiple levels of tempering, 810, before stopping the flow of current. Multiple levels of tempering can either increase or decrease in either time or electrical current to further control the rate of cooling of materials to meet the demands of the material being joined, as long as there is no stoppage of electrical current. The process will still conclude by utilizing the pressure from the electrode surfaces 112, 122 to hold the metal parts 130, 140 together for a specified amount of time. While the present example shown has two tempering steps 330, 810, it is noted that any other suitable plurality of tempering steps can alternatively be utilized if desired. FIG. 8A is a flowchart of the example having process steps 210, 310, 320, 220, 330, 810, 230, and 240. FIG. 8B is a weld graph of the example. FIG. 8B presents the weld graph by charting the progression of the electrical current flowing through the metal parts 130, 140 over time from process step 210 to process step 240.

While the figures are examples of successful programs for welding dissimilar materials, the invention disclosed herein is not limited to only the figures given above. Any quantity and combination of steps can be used, as long as the weld program is a continuous, multi-tiered process. The electrical current provided to the work pieces 130, 140 does not need to be contained to a constant current level and can fluctuate in either a pulsing or sloping method as long as electric current continually runs through the work pieces 130, 140.

Any of the features or attributes of the above described embodiments and variations can be used in combination with any of the other features and attributes of the above described embodiments and variations as desired.

The presently disclosed embodiments provide considerable efficiencies to welding operations, such as cost and time savings. For example, the ability to successfully join dissimilar materials without the use of a fastener saves money in most of the applications it is used. The simple, but novel task of removing a fastener from every single joint will give the entity that applies this process an advantage by removing the cost and weight of every single fastener that would traditionally join dissimilar materials together. The lack of a fastener, as well as the ability to use traditional weld tooling, and line layouts, gives significant savings across a continuous period of time. This solution also saves a significant amount of time compared to other welding solutions by keeping a consistent level of energy running through the interface. This allows for a higher amount of energy to be delivered in a shorter time span as we do not have the intermittent stops in delivering current.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A resistance spot welding method for joining work pieces of dissimilar materials together, the method comprising the steps of:
pressuring the work pieces to clamp the work pieces together with opposed weld electrodes of a weld machine;
in a preheating phase, with the work pieces pressured and clamped together by the weld electrodes, providing electrical current through the weld electrodes to the work pieces at a predetermined level and for a predetermined period of time to provide gradual heating of the work pieces;
in a welding phase after the preheating phase, with the work pieces pressured and clamped together by the weld electrodes, providing electrical current through the weld electrodes to the work pieces at a predetermined level higher than the preheating phase and for a predetermined period of time to form an Intermetallic Compound (IMC) between the work pieces; and
wherein the electrical current is continuously provided to the work pieces from the preheating phase through welding phase without stops.

2. The resistance spot welding method of claim 1, further comprising a sloping phase between the preheating phase and the welding phase, with the work pieces pressured and clamped together by the weld electrodes, wherein electrical current provided to the work pieces gradually rises from the predetermined level of the preheating phase to the predetermined level of the welding phase over a predetermined period of time.

3. The resistance spot welding method of claim 2, wherein there is a plurality of the preheating phases each having different predetermined levels of electrical current.

4. The resistance spot welding method of claim 1, wherein there is a plurality of the welding phases each having different predetermined levels of electrical current.

5. The resistance spot welding method of claim 1, further comprising tempering phase after the welding phase, and with the work pieces pressured and clamped together by the weld electrodes, providing electrical current through weld electrodes to the work pieces at a predetermined level lower than the predetermined level of the welding phase to gradually cool down the work pieces providing;

6. The resistance spot welding method of claim 5, wherein the tempering phase cools down the work pieces with a constant predetermined level of electrical current.

7. The resistance spot welding method of claim 5, wherein the tempering phase is at a lower electrical current level than the weld phase and at a lower or equal electrical current level than the preheat phase.

8. The resistance spot welding method of claim 5, wherein there is a plurality of the tempering phases each having different predetermined levels of electrical current.

9. The resistance spot welding method of claim 5, further comprising the step of increasing a rate of cooling of the work pieces after the tempering phase using cooling fluid flowing in the weld electrodes while the weld electrodes continue to pressure and clamp the work pieces together for a predetermined period of time with constant pressure and no electrical current flowing to the work pieces.

10. The resistance spot welding method of claim 1, further comprising the step of increasing a rate of cooling of the work pieces after the welding phase using cooling fluid flowing in the weld electrodes while the weld electrodes continue to pressure and clamp the work pieces together for a predetermined period of time with constant pressure and no electrical current flowing to the work pieces.

11. The resistance spot welding method of claim 10, wherein there are no stops in the electrical current in the work pieces from the time the weld electrodes first clamp the work pieces together until the end of the tempering phase and the weld electrodes continue to clamp the work pieces with cooling fluid flowing through the weld electrodes.

12. The resistance spot welding method of claim 1, wherein the weld electrodes each have a contact surface that is oriented so that current flow in the work pieces facilitates Peltier Effect.

13. The resistance spot welding method of claim 1, wherein a contact surface of the weld electrodes that is contacting a more conductive one of the dissimilar materials has an equivalent ratio of diameter to a contact surface of the electrodes contacting a less conductive one of the materials to counteract a gap in thermal conductivity and thermal expansion between the dissimilar materials.

14. The resistance spot welding method of claim 1, wherein the electrical current provided to the work pieces is not at a constant current level in each phase and fluctuates in either a pulsing or sloping method while the electric current continually runs through the work pieces.

15. The resistance spot welding method of claim 1, wherein dissimilar materials are aluminum and steel.

16. A resistance spot welding method for joining work pieces of dissimilar materials together, the method comprising the steps of:
pressuring the work pieces to clamp the work pieces together with opposed weld electrodes of a weld machine;
in a preheating phase, with the work pieces pressured and clamped together by the weld electrodes, providing electrical current through the weld electrodes to the work pieces at a predetermined level and for a predetermined period of time to provide gradual heating of the work pieces;
in a welding phase after the preheating phase, with the work pieces pressured and clamped together by the weld electrodes, providing electrical current through the weld electrodes to the work pieces at a predetermined level higher than the preheating phase and for a predetermined period of time to form an Intermetallic Compound (IMC) between the work pieces;
a sloping phase between the preheating phase and the welding phase, with the work pieces pressured and clamped together by the weld electrodes, wherein electrical current provided to the work pieces gradually rises from the predetermined level of the preheating phase to the predetermined level of the welding phase over a predetermined period of time;
increasing a rate of cooling of the work pieces after the tempering phase using cooling fluid flowing in the weld electrodes while the weld electrodes continue to pressure and clamp the work pieces together for a predetermined period of time with constant pressure and no electrical current flowing to the work pieces; and
wherein the electrical current is continuously provided to the work pieces throughout the preheating, sloping, and welding phases without stops.

17. The resistance spot welding method of claim 16, further comprising tempering phase after the welding phase and before the increased rate of cooling step, and with the work pieces pressured and clamped together by the weld electrodes, providing electrical current through the weld electrodes to the work pieces at a predetermined level lower than the predetermined level of the welding phase to gradually cool down work pieces providing.

18. The resistance spot welding method of claim 17, wherein the tempering phase is at a lower electrical current level than the weld phase and at a lower or equal electrical current level than the preheat phase.

19. The resistance spot welding method of claim 17, wherein there are no stops in the electrical current in the work pieces from the time the weld electrodes first clamp the work pieces together until the end of the tempering phase.

20. The resistance spot welding method of claim 16, wherein the dissimilar materials are aluminum and steel.
